(19) United States
(12) Patent Application Publication
(10) Pub. No.: US 2023/0144674 A1
(43) Pub. Date: May 11, 2023

(54) USER STATUS SYNCHRONIZATION AMONG WORKSPACE APPLICATIONS

(71) Applicant: Citrix Systems, Inc., Ft. Lauderdale, FL (US)

(72) Inventors: Zongpeng Qiao, Nanjing (CN); Ke Xu, Nanjing (CN); Shutian Yao, Nanjing (CN)

(73) Assignee: Citrix Systems, Inc., Ft. Lauderdale, FL (US)

(21) Appl. No.: 17/644,826

(22) Filed: Dec. 17, 2021

Related U.S. Application Data
(63) Continuation of application No. PCT/CN2021/129973, filed on Nov. 11, 2021.

(51) Int. Cl. H04L 67/54; H04L 51/02

(52) U.S. Cl. CPC H04L 67/24; H04L 51/02

(57) ABSTRACT

A computing device configured to determine current user status information is provided. The computing device includes a computer readable memory, a network interface, and at least one processor operably coupled to the memory and the network interface. The at least one processor can be configured to receive, via the network interface from a first end-user application being of a first type, a first message specifying status information of a first user, process the status information of a first user to determine current user status information for the first user, generate a second message specifying the current user status information for the first user, and transmit the second message to a second end-user application being of a second type distinct from the type of the first end-user application such that at least one second user can review the current status information for the first user.

### CROSS-REFERENCE TO RELATED APPLICATION

This application claims priority under 35 U.S.C. § 120 as a continuation of PCT Application No. PCT/CN2021/129973, titled “USER STATUS SYNCHRONIZATION AMONG WORKSPACE APPLICATIONS” and filed Nov. 11, 2021. PCT Application No. PCT/CN2021/129973 is hereby incorporated herein by reference in its entirety.

### BACKGROUND

In network environments, a server can host or provide access to a plurality of resources or applications for a plurality of users. These applications typically include one or more applications that are configured to provide status information for a user. For example, included in standard features with most messaging applications is a limited visual indication of a user's availability. Similarly, a scheduling application can include an indication of a user's planned availability based upon information the user has entered into their personal schedule such as upcoming paid time off. However, a user's real-time availability is generally based upon currently provided user information as provided to an individual application, and information available to additional users is limited to that specific application.

### SUMMARY

In at least one example, a computing device configured to determine current user status information is provided. The computing device includes a computer readable memory, a network interface, and at least one processor operably coupled to the memory and the network interface. The at least one processor can be configured to receive, via the network interface from a first end-user application being of a first type, a first message specifying status information of a first user, process the status information of a first user to determine current user status information for the first user, generate a second message specifying the current user status information for the first user, and transmit the second message to a second end-user application being of a second type distinct from the type of the first end-user application such that at least one second user can review the current status information for the first user.

Implementations of the computing device configured to configured to determine current user status information can include one or more of the following features.

In examples of the computing device, the at least one processor can be further configured to receive a plurality of first messages specifying status information of the first user, process the plurality of first messages to generate a chronological list of user status updates, and determine the current user status information based upon the chronological list of user status updates.

In examples of the computing device, the at least one processor can be further configured to poll the first end-user application for the status information of the first user.

In examples of the computing device, the at least one processor can be further configured to transmit a subscription request to the first end-user application, the subscription request including one or more instructions to the first end-user application to automatically send the status information of the first user to the at least one processor.

In examples of the computing device, the at least one processor can be further configured to receive updated user status information from the first end-user application, process the updated user status information to generate an updated user status, and cause the updated user status to be broadcast to a plurality of second end-user applications such that each of the plurality of second end-user applications displays the updated user status to additional users of the plurality of second end-user applications.

In examples of the computing device, the at least one processor can be configured to receive the first message specifying status information of a first user from the first end-user application by being configured to monitor interaction between the first user and the first end-user application to produce monitored interaction information, determine real-time activity information for the first user based upon the monitored interaction information, and generate the second message specifying the current user status information for the first user based upon the real-time activity information.

In examples of the computing device, the user status information can include an indication that the first user is one or more of on paid time off, away from their computer, currently active in a scheduled activity, available, participating in a chat session, on a call, in a conference meeting, or attending a training session.

In another example, a method for determining current user status information is provided. The method includes receiving, by at least one processor, a first message specifying status information of a first user from a first end-user application being of a first type; processing, by the at least one processor, the status information of a first user to determine current user status information for the first user; generating, by the at least one processor, a second message specifying the current user status information for the first user; and transmitting, by the at least one processor, the second message to a second end-user application being of a second type distinct from the type of the first end-user application such that at least one second user can review the current status information for the first user.

Implementations of the method for determining current user status information can include one or more of the following features.

In some examples of the method, the method can further include receiving, by the at least one processor, a plurality of first messages specifying status information of the first user; processing, by the at least one processor, the plurality of first messages to generate a chronological list of user status updates; and determining, by the at least one processor, the current user status information based upon the chronological list of user status updates.

In some examples of the method, the method can further include polling, by the at least one processor, the first end-user application for the status information of the first user.

In some examples of the method, the method can further include transmitting, by the at least one processor, a subscription request to the first end-user application, the subscription request including one or more instructions to the first end-user application to automatically send the status information of the first user to the at least one processor.

In some examples of the method, the method can further include receiving, by the at least one processor, updated user status information from the first end-user application; processing, by the at least one processor, the updated user status information to generate an updated user status; and causing, by the at least one processor, the updated user status to be broadcast to a plurality of second end-user applications such that each of the plurality of second end-user applications displays the updated user status to additional users of the plurality of second end-user applications.

In examples of the method, receiving the first message specifying status information of a first user from the first end-user application can include monitoring, by the at least one processor, interaction between the first user and the first end-user application to produce monitored interaction information; determining, by the at least one processor, real-time activity information for the first user based upon the monitored interaction information; and generating, by the at least one processor, the second message specifying the current user status information for the first user based upon the real-time activity information.

In an additional example, a non-transitory computer-readable medium storing computer-executable instructions to determine current user status information is provided. The instructions can include instructions to receive a first message specifying status information of a first user from a first end-user application being of a first type, process the status information of a first user to determine current user status information for the first user, generate a second message specifying the current user status information for the first user, and transmit the second message to a second end-user application being of a second type distinct from the type of the first end-user application such that at least one second user can review the current status information for the first user.

Implementations of the non-transitory computer-readable medium storing computer-executable instructions to determine current user status information can include one or more of the following features.

In examples of the non-transitory computer-readable medium, the instructions can further include instructions to receive a plurality of first messages specifying status information of the first user, process the plurality of first messages to generate a chronological list of user status updates, and determine the current user status information based upon the chronological list of user status updates.

In examples of the non-transitory computer-readable medium, the instructions can further include instructions to poll the first end-user application for the status information of the first user.

In examples of the non-transitory computer-readable medium, the instructions can further include instructions to transmit a subscription request to the first end-user application, the subscription request including one or more instructions to the first end-user application to automatically send the status information of the first user to at least one processor.

In examples of the non-transitory computer-readable medium, the instructions can further include instructions to receive updated user status information from the first end-user application, process the updated user status information to generate an updated user status, and cause the updated user status to be broadcast to a plurality of second end-user applications such that each of the plurality of second end-user applications displays the updated user status to additional users of the plurality of second end-user applications.

In examples of the non-transitory computer-readable medium, the instructions to receive the first message specifying status information of a first user from the first end-user application can include instructions to monitor interaction between the first user and the first end-user application to produce monitored interaction information, determine real-time activity information for the first user based upon the monitored interaction information, and generate the second message specifying the current user status information for the first user based upon the real-time activity information.

In examples of the non-transitory computer-readable medium, the user status information can include an indication that the first user is one or more of on paid time off, away from their computer, currently active in a scheduled activity, available, participating in a chat session, on a call, in a conference meeting, or attending a training session.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a system architecture for accessing a distributed workspace by multiple client devices.

FIGS. 2A and 2B illustrate application flow diagrams for providing user status information over a distributed workspace in accordance with examples of the present disclosure.

FIG. 3 is a block diagram of a system architecture for syncing user status information over multiple applications in a distributed workspace in accordance with an example of the present disclosure.

FIG. 4 is a block diagram of a sample network environment of computing devices in which various aspects of the present disclosure can be implemented.

FIG. 5 is a block diagram of a cloud computing environment in which various aspects of the present disclosure can be implemented.

FIG. 6 is a flow diagram for determining a current user status for a user of one or more workspace applications, in accordance with an example of the present disclosure.

FIG. 7 is an alternative flow diagram for determining a current user status for a user of one or more workspace applications, in accordance with an example of the present disclosure.

FIG. 8 is a flow diagram for updating the current user status for a user of one or more workspace applications, in accordance with an example of the present disclosure.

FIG. 9 is a sample sequence diagram for determining a current user status for a user of one or more workspace applications, in accordance with an example of the present disclosure.

FIG. 10 is a sample sequence diagram for updating the current user status for a user of one or more workspace applications, in accordance with an example of the present disclosure.

FIG. 11 is a block diagram of one or more of the computing devices as described herein, in accordance with an example of the present disclosure.

### DETAILED DESCRIPTION

As summarized above, various examples described herein are directed to systems and methods for providing dynamic and intelligible status updates for users of one or more distributed workspace applications. For example, the systems and methods as described herein monitor both scheduled user activity as well as dynamic user information for an individual user to determine their current status, and broadcasts this user status information to additional workspace applications such that users of those additional applications can receive updated status information for the individual user.

In some distributed workspaces, some applications are configured to determine the current user status such as user availability information, whether the user is engaged in a call within the application, whether the user has a calendar event for a current time, another similar limited status information. However, in a typical distributed workspace, this information is not shared between applications. For example, if a user enters their current status within in a messaging application, other users of the messaging application may be able to access the user status information. However, users of other applications such as a task assignment application may not have access to the current user status information as defined within the messaging application. As such, a user may be required to enter their current status in multiple applications such that users of the different applications can access a user's updated status information.

The systems and methods as described herein overcome the disadvantages and limitations of traditional status distribution techniques by providing a current user status as received from a first application to users of multiple different applications within a distributed workspace. The current user status can be automatically determined based upon user interaction with the system or in response to a user-provided status update. Such systems and methods as described herein provide various advantages to improve traditional status tracking and updating within distributed workspace applications. In certain implementations, the systems and methods as described herein can provide users with additional information that may be beneficial to them when, for example, making decisions regarding scheduling events such as meeting times and/or task assignments. For example, by automating the distribution of user status information, the burden on a user to update multiple applications to include their current user status is removed. Similarly, a person checking another user's status can have a level of assurance that the status information they are seeing for a particular user is the most recent and updated status information for that user. Such current status information collection and distribution is unavailable with traditional distributed workspace applications as traditional workspace applications do not share or otherwise distribute status information between application types.

Thus, and in accordance with at least some examples disclosed herein, systems and methods for monitoring and broadcasting current user status information between multiple workspace applications within a distributed workspace is provided. These systems and methods enhance the quality of a user's experience with applications within a distributed workspace by providing an accurate and dynamically updated current status for each user accessing the one or more applications within the distributed workspace.

In some examples, a computing device for determining current user status information is provided. The computing device includes a computer readable medium and at least one processor operably coupled to the computer readable medium. The at least one processor can be configured to receive user status information for a user of a client workstation from at least one client application running on the client workstation, process the user status information to generate a chronological list of user status updates, generate a current user status based upon a most recent user status update in the chronological list, and broadcast the current user status to multiple client applications such that each of the client applications can display the current user status to additional users of the client applications.

Examples of the methods, systems, and processes discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Sample Computing Systems

In some examples, a distributed system is configured to implement workspace and system access to remote users, thereby providing a central repository of applications, files, and other similar resources to a group of trusted users accessible via, for example, an enterprise service. A distributed workspace can be implemented as a software platform designed to deliver and manage a user's applications, data, and desktops in a consistent and secure manner, regardless of the user's device or location. Distributed workspaces enhance the user experience by streamlining and automating those tasks that a user performs frequently, such as approving expense reports, confirming calendar appointments, submitting helpdesk tickets, and reviewing vacation requests. A distributed workspace allows users to access functionality provided by multiple enterprise applications—including software as a system (SaaS) applications, web applications, desktop applications, and proprietary applications—through a single interface.

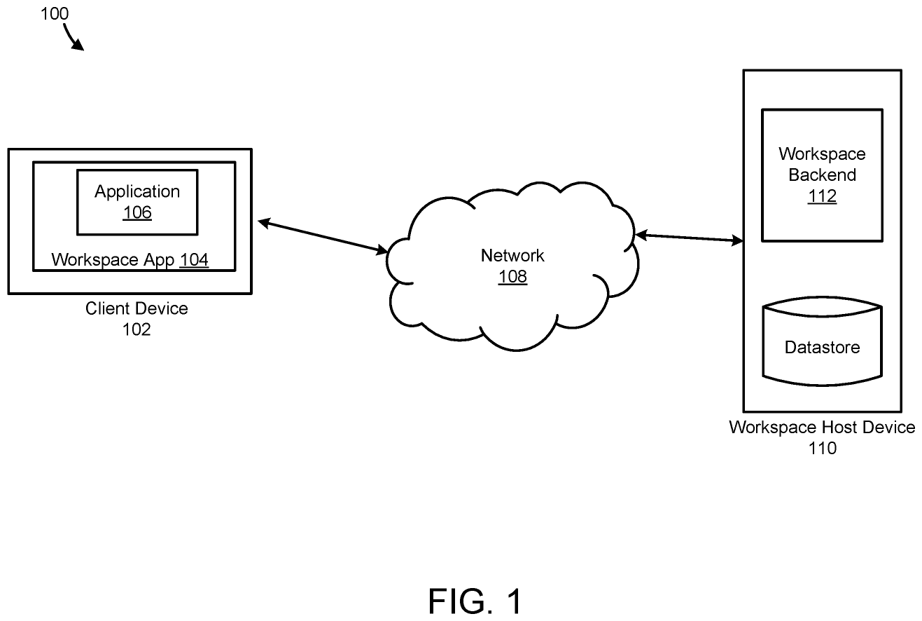

FIG. 1 illustrates a logical architecture of one implementation of, for example, a distributed workspace system 100 that is configured to connect one or more client computing devices with one or more remote computing devices configured to host shared resources such as applications accessible via the distributed workspace. As shown in FIG. 1, the system 100 can include a client device 102. As further shown in FIG. 1, the client device 102 can include a workspace application 104. The workspace application 104 can be configured to provide an interface to facilitate remote access to one or more resources hosted at or by, for example, a remote computing device such as workspace host device 110. In certain implementations, the client device 102 can be operably connected to the remote computing device via one or more networks 108. In some examples, the network 108 can be a wired network, a wireless network, or a combination of both wired and wireless networks.

In some examples, the workspace host device 110 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol (HTTP) client; a File Transfer Protocol (FTP) client; an Oscar client; a Telnet client; or any other set of executable instructions.

In some examples, the workspace host device 110 can execute a remote presentation services program or other program that uses a thin client or a remote-display protocol to capture display output generated by an application executing on the remote computing device and transmit the application display output to the client device 102 for presentation to one or more device users.

In some examples, the workspace host device 110 can include a server agent that is configured to communicate with the workspace application 104. The server agent can be configured to, for example, authenticate a client device, provide secure access to one or more remote and/or shared resources, monitor user interactions with the resources, update user access based upon changes to user permission levels for a client device, distribute or properly direct requests to available resources, and perform other similar distributed workspace functions.

In yet other examples, the workspace host device 110 can be configured to execute a virtual machine providing access to a computing environment to a user of client device 102. The virtual machine can be managed by, for example, a hypervisor, a virtual machine manager (VMM), or any other hardware virtualization technique within the workspace host device 110.

In some examples, the network 108 can be: a local area network (LAN); a metropolitan area network (MAN); a wide area network (WAN); a primary public network; and a primary private network. Additional examples can include a network 108 of mobile telephone networks that use various protocols to communicate among mobile devices. For short range communications within a wireless local-area network (WLAN), the protocols can include 802.11, Bluetooth, and Near Field Communication (NFC).

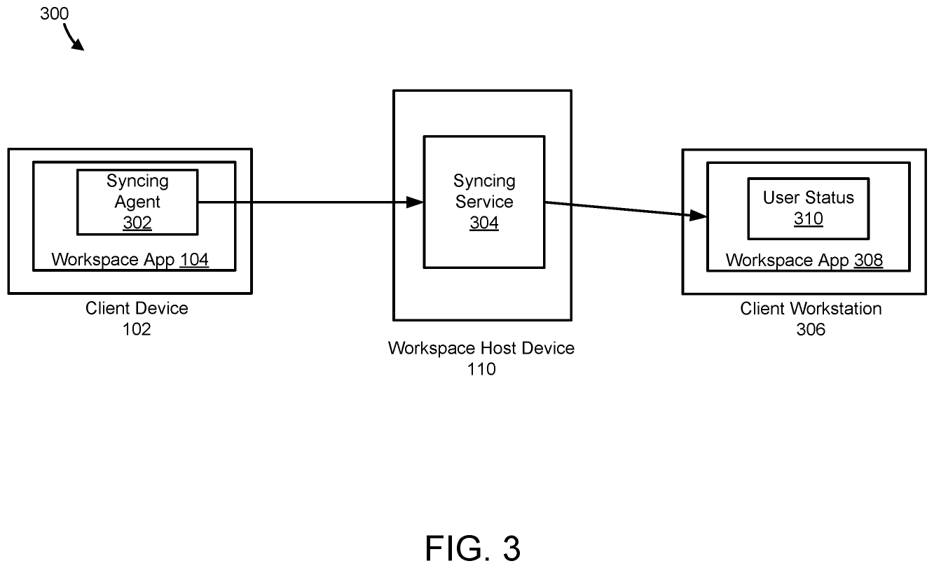

It should be noted that the specific device architecture as shown in FIG. 1 is provided by way of example only. For instance, in certain implementations, multiple remote computing devices can be operably connected to the client devices via, for example, one or more network appliances configured to perform, for example, access control and load balancing. Additional network examples and associated devices are described below in the discussion of FIG. 3.

In a typical distributed workspace, a user of the client device 102 can access an additional application 106 through, for example, the workspace application 104. For example, the application 106 can include a scheduling application, a task assignment/management application, a billing application, a word processing application, a spreadsheet application, a coding application, a chat application, an email client application, a calendar application, a conferencing application, a file management application, and other similar applications that a user may interact with during a distributed workspace session. The workspace application 104, in communication with the workspace backend 112, can control user access to the application 106 based upon, for example, application access and security information associated with the user of the client device 102.

As described herein, synchronization tools are provided to users of a distributed workspace such that user status information is shared between multiple applications within the distributed workspace. For example, when a user enters their current status into an application within the distributed workspace or, in some examples, the application automatically determines the current status for the user, the status information is automatically determined by, for example, a syncing agent. The syncing agent can be further configured work in concert with a syncing service to distribute, or cause distribution of, the user status information to all other applications within the distributed workspace that provide an indication of current user status. As such, the systems and methods as described herein can provide for sharing of both user provided status information and automatically detected user status information within, for example, a distributed workspace.

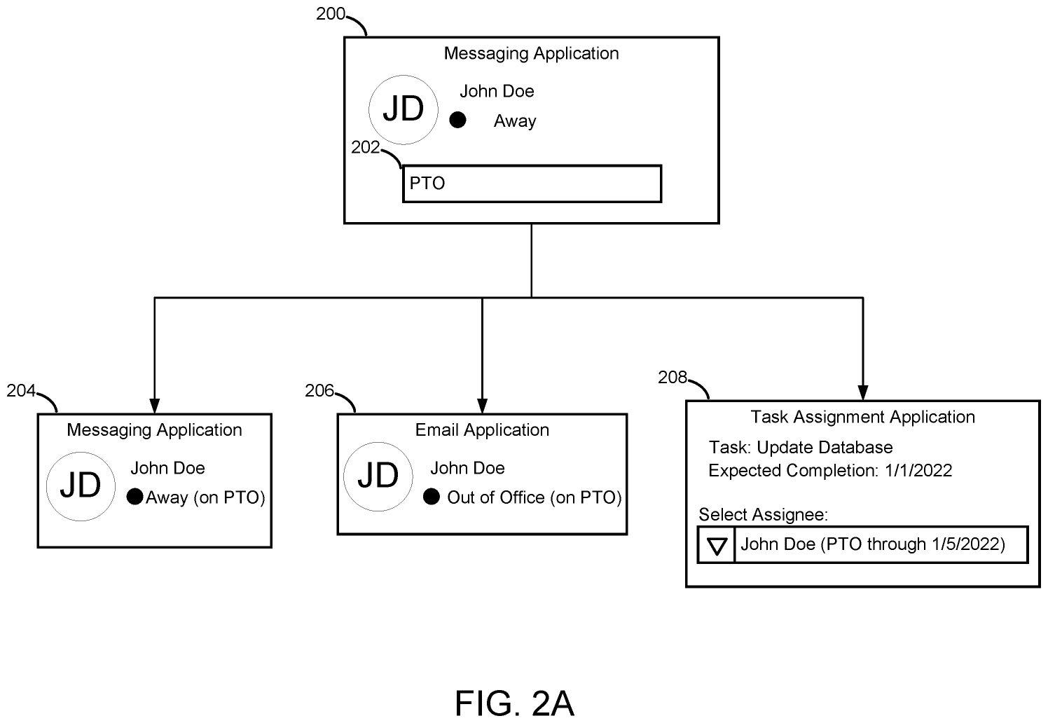

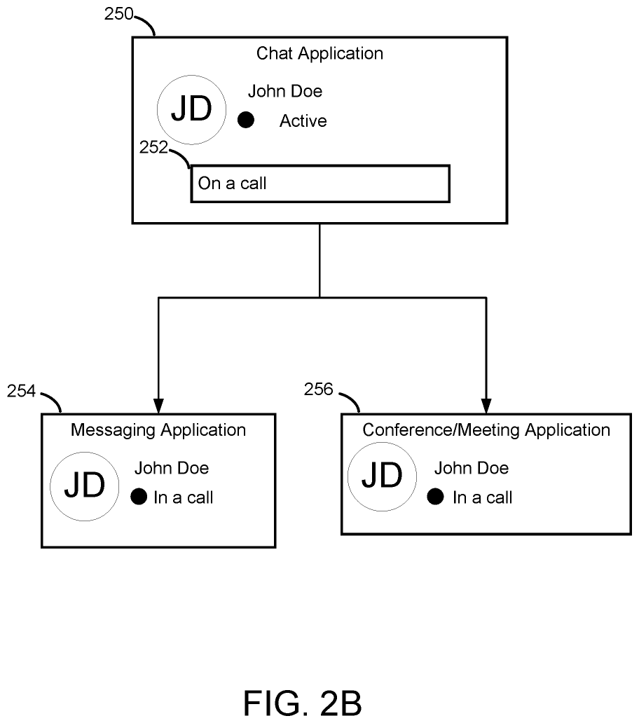

For instance, FIG. 2A illustrates an example where a user provided status update can be distributed from a first application two additional applications within a distributed workspace. As shown in FIG. 2A, a user can access an interface 200 associated with a first application within the distributed workspace. For example, as shown in FIG. 2A, the interface 200 is associated with a messaging application. Within the messaging application, the user can access a user control 202 to provide their current user status. As shown in FIG. 2A, the user has accessed the user interface 200 and entered paid time off within the user control 202. In such an example, a processing device implementing a process such as the syncing agent as described hereinbelow can receive the information entered within the user control 202 within the user interface 200. The syncing agent can process the information to determine the current status for user John Doe as entered above, and distribute the information to additional applications within the distributed workspace using, for example, a syncing service as also described hereinbelow. For example, as further shown in FIG. 2A, applications 204, 206, and 208 can be updated to display the current user status information for John Doe. In such an example, additional users of alternative workspace applications can quickly determine the current status of John Doe. For example, application 208 includes a task assignment application. When a manager or other similar assignor of a task selects John Doe to assign to a task, the manager can quickly determine that John Doe is on paid time off. By using the systems and methods as described herein, user status information that might not otherwise be shared between applications can be shared to harmonize user status information across all applications within a distributed workspace.

In some examples, in addition to a user providing their current status, the systems and methods as described herein can automatically determine the status of a user based upon the user's activity. For example, as shown in FIG. 2B, a user may be accessing a chat application 250. In certain implementations of the chat application 250, the application can include a status control 252 that provides an indication of the current user activity within that application. As shown in FIG. 2B, the user John Doe is currently on a call within the chat application 250. In such an example, a processing device can automatically monitor and determine the current user status based upon the user's activity within a particular application. In the example as shown in FIG. 2B, the processing device can automatically determine that user John Doe is engaged on a call within the chat application 250 and can cause the current status of the user to be broadcast to additional applications within the distributed workspace. For example, messaging application 254 can be updated to provide an indication that John doe is engaged on a call. Similarly, conference/meeting application 256 can be updated to indicate that the current status of John Doe is “In a call.”

As noted above, the methods and systems as described herein can use one or more processing devices such as a syncing agent and syncing service to provide user status information synchronization between multiple applications within a distributed workspace. FIG. 3 illustrates a sample system 300 including one or more processing devices configured to provide for synchronization of user status information as described herein.

For example, a client workstation such as client device 102 as shown in FIG. 1 can be configured to run workspace application 104. As described above, the workspace application 104 can be configured to run one or more distributed workspace applications such as application 106 as shown in FIG. 1. As further shown in FIG. 3, the workspace application 104 can be configured to include an additional process such as syncing agent 302. As described herein, the syncing agent 302 can be configured to monitor for and determine current user status information such as that described herein. For example, the syncing agent 302 can be configured to monitor user interactions with additional applications running within the workspace application 104 to determine current user interaction information. Additionally, the syncing agent 302 can be configured to monitor user interaction with one or more applications within the workspace application 104 to determine user provided status information as described herein.

As further shown in FIG. 3, the syncing agent 302 can be operatively connected to a syncing service 304 running on, or otherwise implemented by, workspace host device 110. As described herein, the syncing service 304 can be configured to collect user status information from the syncing agent 302 and broadcast the user status information to additional applications within the distributed workspace. In such an example, users of the additional applications can access user status information for other users that otherwise would be unavailable. For example, as shown in FIG. 3, a user of client workstation 306 can access workspace application 308. Within workspace application 308, each application the user accesses can include user status 310 that provides an indication of the current user status of the user of client device 102. In such an example, user status information can be shared among applications that traditionally would not have access to current user status as defined within another application in the distributed workspace.

In certain implementations, the user of a client device such as client device 102 can interact with the syncing agent 302 to limit the scope of user status information that is available to other users via the syncing service 304 as described herein. For example, the user can set one or more limits that define the type of information to share with others as well as define which of the other users have access to a particular type of information. For example, using organization group information defined, in certain examples, by an internal directory service, a user can set what types of information are available to which particular members/ranks/roles within an organization. For example, if the user has set their status to “Out of Office: doctor's appointment,” the user can define that non-management users (as defined, for example, by the directory service) will see the user's status as “Out of Office,” while a manager would see the additional detail “doctor's appointment.” It should be noted that this is provided by way of discussion only as an example of limiting the scope of information delivered to additional users regarding the current status of another user as described herein.

Referring back to FIG. 3, it should be noted that the location of various components within system 300 is provided by way of example only. For instance, syncing agent 302 is shown as running within workspace application 104 as an example and could be implemented in additional locations within the system 300. For example, the workspace host device 110 can be configured to host both the syncing agent 302 and the syncing service 304. In such an example, the syncing agent 302 can be operatively coupled to or otherwise configured to monitor user interactions with workspace application 104 to determine current user status information as described herein.

In certain implementations, the syncing agent 302 can be implemented as a browser extension configured to run in concert with the workspace application 104 on client device 102. The syncing agent 302 can be configured to monitor for activity in instances of individual applications running within the workspace application to determine or otherwise obtain, for example, user activity information as described herein. In other examples, the syncing agent 302 can be implemented as an application run by the operating system of the client device 102. In such an example, the syncing agent 302 can be configured to operate in parallel with the workspace application 104 to obtain and/or determine information related to the user of the client device 102 such as the current user status information as described herein. Similarly, the syncing service 304 can be implemented as an application within a gateway device such as workspace host device 110. For example, the syncing service 304 can be implemented as an added service to a workspace application hosting process as implemented by the workspace host device 110 (hosted, for example, by workspace backend 112). In other examples, the syncing service can be implemented as a standalone application natively run by the operating system of a gateway device such as the workspace host device 110, running in parallel with the workspace application hosting process.

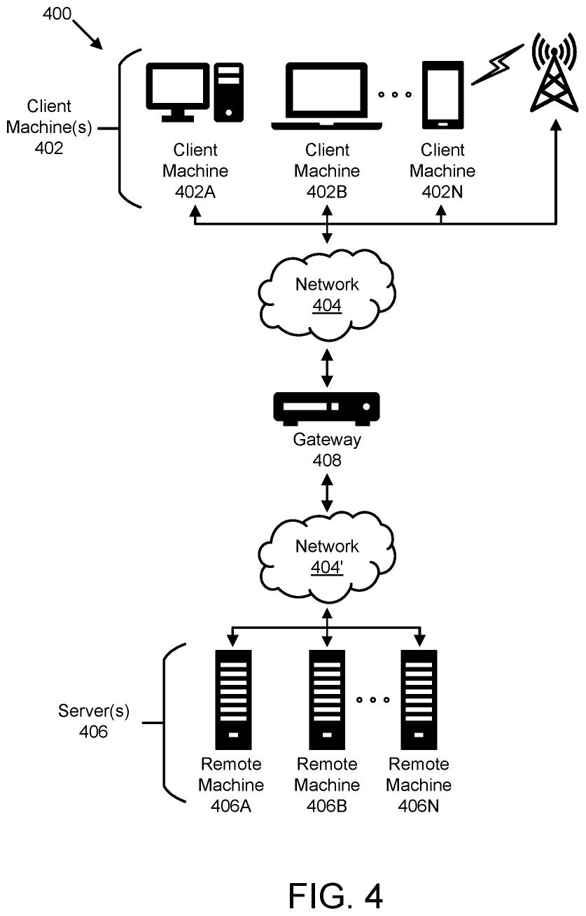

As noted above in FIG. 1, various computing devices can be arranged into one or more interconnected networks to provide user access to remote resources through various client devices. Referring to FIG. 4, a non-limiting network environment 400 provides an alternative arrangement to network 100 as shown in FIG. 1, in which various aspects of the disclosure can be implemented. As shown in FIG. 4, the environment 400 includes one or more client machines 402A-402N, one or more remote machines 406A-406N, one or more networks 404, 404′, and one or more appliances 408 installed within the computing environment 400. The client machines 402A-402N communicate with the remote machines 406A-406N via the networks 404, 404′. The computing environment 400 can also be referred to as a distributed computer system.

In some examples, the client machines 402A-402N communicate with the remote machines 406A-406N via an intermediary appliance 408. The illustrated appliance 408 is positioned between the networks 404, 404′ and can also be referred to as a network interface or gateway. In some examples, the appliance 408 can operate as remote computing device configured to provide clients with access to business applications and other data deployed in a datacenter, the cloud, or delivered as SaaS applications across a range of client devices, and/or provide other functionality such as load balancing, etc. In some examples, multiple appliances 408 can be used, and the appliance(s) 408 can be deployed as part of the network 404 and/or 404′.

The client machines 402A-402N can be generally referred to as client machines 402, local machines 402, clients 402, client nodes 402, client computers 402, client devices 402, computing devices 402, endpoints 402, or endpoint nodes 402. In certain implementations, client machines 402 can include, for example, client device 102 as shown in FIG. 1 and described above.

The remote machines 406A-406N can be generally referred to as servers 406 or a server farm 406. In some examples, a client device 402 can have the capacity to function as both a client node seeking access to resources provided by a server 406 and as a server 406 providing access to hosted resources for other client devices 402A-402N. The networks 404, 404′ can be generally referred to as a network 404. The networks 404 can be configured in any combination of wired and wireless networks.

A server 406 can be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality. In some examples, a server 406 can include the functionality of the workspace host device 110 as shown in FIG. 1 and described above.

A server 406 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol client; a File Transfer Protocol client; an Oscar client; a Telnet client; or any other set of executable instructions.

In some examples, a server 406 can execute a remote presentation services program or other program that uses a thin client or a remote-display protocol to capture display output generated by an application executing on a server 406 and transmit the application display output to a client device 402.

In yet other examples, a server 406 can execute a virtual machine providing, to a user of a client device 402, access to a computing environment. The client device 402 can be a virtual machine. The virtual machine can be managed by, for example, a hypervisor, a virtual machine manager (VMM), or any other hardware virtualization technique within the server 406.

In some examples, the network 404 can be: a LAN; a MAN; a WAN; a primary public network; and a primary private network. Additional examples can include a network 404 of mobile telephone networks that use various protocols to communicate among mobile devices. For short range communications within a WLAN, the protocols can include 802.11, Bluetooth, and NFC. In certain examples, the network 404 can include network 108 as shown in FIG. 1 and described above.

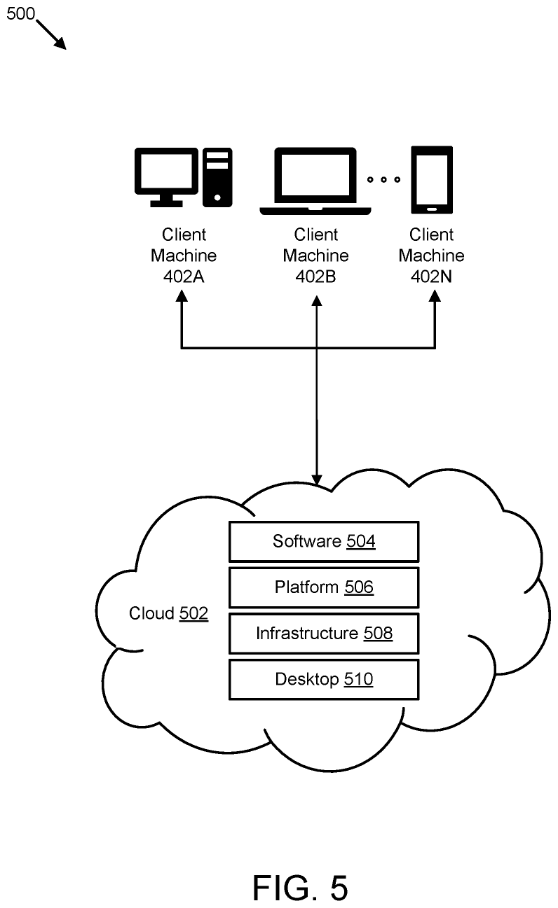

Referring to FIG. 5, a cloud computing environment 500 is depicted, which can also be referred to as a cloud environment, cloud computing or cloud network. The cloud computing environment 500 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 500, one or more clients 402a-402n (such as those described above and shown in FIG. 4) are in communication with a cloud network 502. The cloud network 502 can include back-end platforms, e.g., servers, storage, server farms or data centers. The users or clients 402a-402n can correspond to a single organization/tenant or multiple organizations/tenants. More particularly, in one example implementation the cloud computing environment 500 can provide a private cloud serving a single organization (e.g., enterprise cloud). In another example, the cloud computing environment 500 can provide a community or public cloud serving multiple organizations/tenants.

In some examples, a gateway appliance(s) or service can be utilized to provide access to cloud computing resources and virtual sessions. By way of example, Citrix Gateway, provided by Citrix Systems, Inc., can be deployed on-premises or on public clouds to provide users with secure access and single sign-on to virtual, SaaS and web applications. Furthermore, to protect users from web threats, a gateway such as Citrix Secure Web Gateway can be used. Citrix Secure Web Gateway uses a cloud-based service and a local cache to check for uniform resource locator (URL) reputation and category.

In still further examples, the cloud computing environment 500 can provide a hybrid cloud that is a combination of a public cloud and a private cloud. Public clouds can include public servers that are maintained by third parties to the clients 402a-402n or the enterprise/tenant. The servers can be located off-site in remote geographic locations or otherwise.

The cloud computing environment 500 can provide resource pooling to serve multiple users via clients 402a-402n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some implementations, the cloud computing environment 500 can provide on-demand self-service to unilaterally provision computing capabilities (e.g., compute time, network storage) across a network for multiple clients 402a-402n. By way of example, provisioning services can be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 500 can provide an elasticity to dynamically scale out or scale in response to different demands from one or more clients 402. In some examples, the cloud computing environment 500 can include or provide monitoring services to monitor, control and/or generate reports corresponding to the provided shared services and resources.

In some implementations, the cloud computing environment 500 can provide cloud-based delivery of different types of cloud computing services, such as SaaS 504, Platform as a Service (PaaS) 506, Infrastructure as a Service (IaaS) 508, and Desktop as a Service (DaaS) 510, for example. IaaS can refer to a user renting the use of infrastructure resources that are needed during a specified time period. IaaS providers can offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers can offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers can offer the resources that PaaS provides, including storage, networking, servers, virtualization, operating system, middleware, or runtime resources. In some examples, SaaS providers can offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS can also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms can be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace application can be used as a single-entry point for bringing apps, files and desktops together (whether on-premises or in the cloud) to deliver a unified experience.

### Sample Process Examples

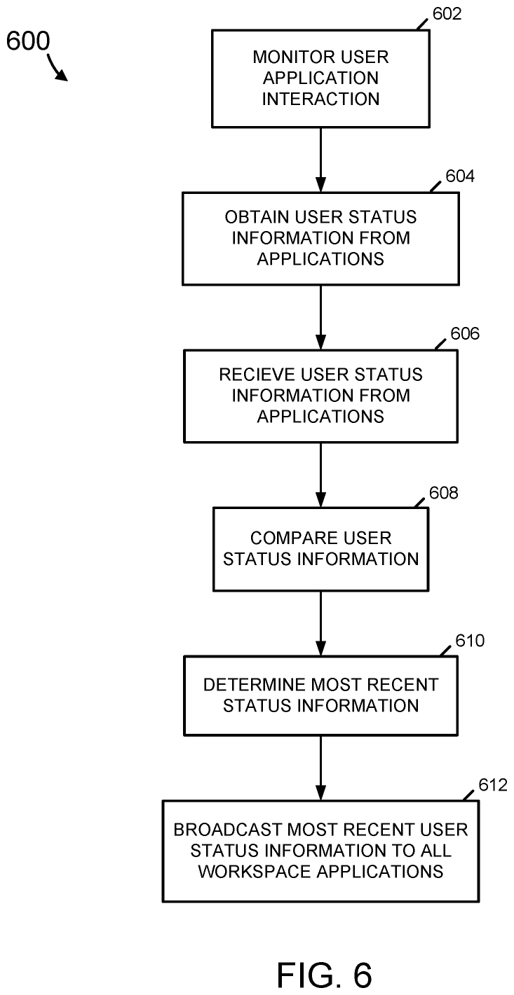

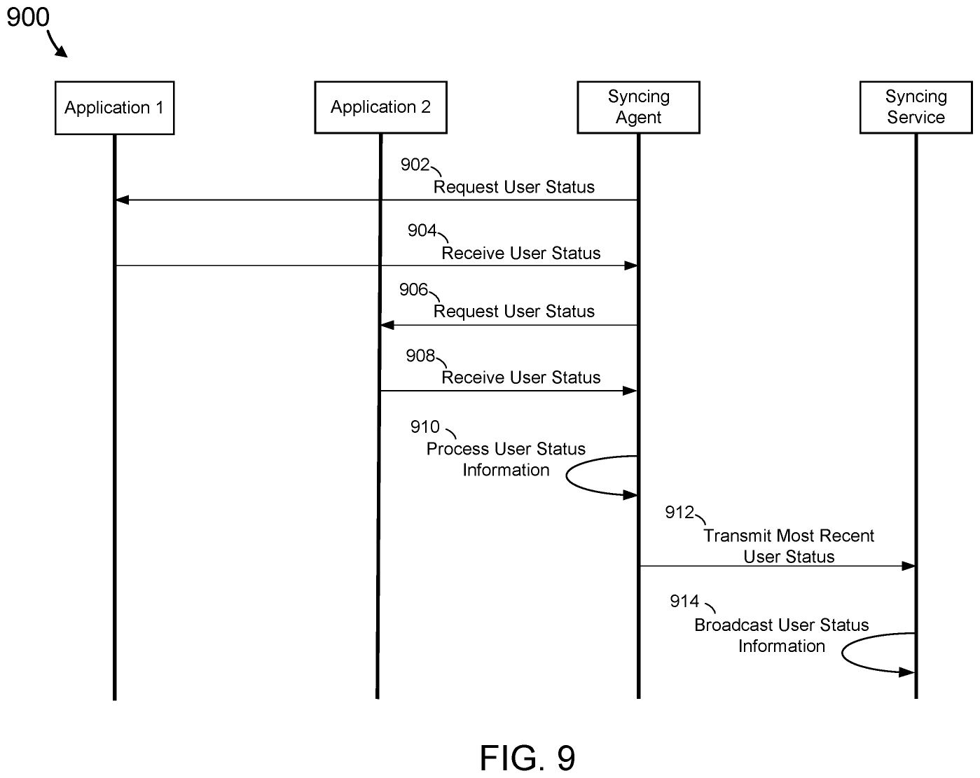

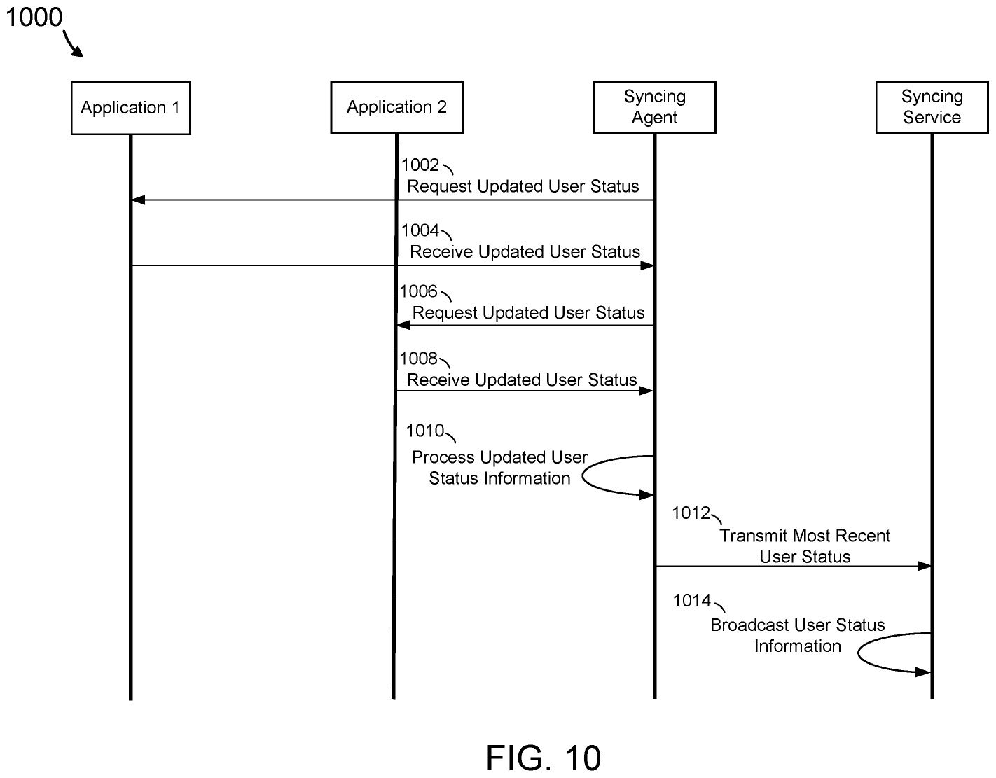

FIG. 6 illustrates the sample process 600 for determining the current status of a user of a client device as it pertains to their availability within a distributed workspace. The process 600 as shown in FIG. 6 can be implemented, for example, by a processor of a computing device such as the client device 102 and/or workspace host device 110 as configured to implement the syncing agent 302 and the syncing service 304 as shown in FIG. 3 and described above. For example, the processor, or a combination of processors and/or processing devices, can be configured to implement one or more of the syncing agent 302 and the syncing service 304 as described herein. In the example processes as shown in FIGS. 6-8 and described above, the processes are described with respect to the one or more processors that are configured to execute a set of instructions to perform the process steps. The sequence diagrams as shown in FIGS. 9 and 10 and described below in greater detail are directed to the processes as executed by the one or more processors (e.g., the syncing agent and syncing service as described herein) and which process implements a particular process step.

As shown in FIG. 6, process 600 can include monitoring 602 user application interactions as described herein. For example, the processor can be configured to execute a software process including one or more instructions, the process configured to monitor 602 user interaction with one or more distributed workspace applications for current user status information. As described herein, the current user status information can include user provided information such as information entered by the user into one or more applications as well as user status information as determined by the process or based upon current user interactions with one or more applications. In certain implementations, the processor can execute one or more additional instructions to cause the process to further obtain 604 user status information from the applications. In certain implementations, the processor can be configured to execute a first process (e.g., the syncing agent as described herein) to interoperate with a second process executed by the processor (e.g., one or more workspace applications) via a set of API calls. For example, the processor can be configured to poll 604 the workspace application(s) using one or more API calls for user status information at certain time intervals such as, for example, every minute, every two minutes, every five minutes, every 10 minutes, every 15 minutes, every 30 minutes, and/or every hour.

As further shown in FIG. 6, the processor can be configured to execute one or more additional instructions to cause the process to receive 606 the user status information from one or more distributed workspace applications. For example, in certain implementations, a user of a client workstation may not have access to all available applications within a distributed workspace. In such an example, the processor can be configured to request and/or receive current user status information only from those applications that the user has access to. In some examples, the user status information as received 606 from the one or more distributed workspace applications can be structured in a particular format. For example, the format can include both status identification information as well as timestamp information. In certain implementations, the user status information can be formatted as {status identifier, timestamp}. In some examples, status identifier can be application specific and selected from a pre-populated list of options. For example, a status identifier can specify a user's status as including one or more of on paid time off, away from computer, currently active in a scheduled activity, available, participating in a chat session, on a call, in a conference meeting, or attending a training session.

Based upon the status identifier and the timestamp information, the processor can execute additional instructions to cause the process to compare 608 user status information as received from one or more applications within the distributed workspace. In certain implementations, the processor can be configured to determine the most recent status information based upon the timestamp information as contained within the user status information. The processor can be further configured to execute additional instructions to cause the process to organize the user status information into a chronological list based upon this timestamp information and determine 610 the most recent status information as included on the chronological list. Once determined, the processor can execute one or more additional instructions to cause the process to broadcast 612 the most recent user status information too some or all of the applications within the distributed workspace. For example, some applications within the distributed workspace may not include the capability of providing user status information. In such an example, the processor can be configured to omit those applications when broadcasting the most recent user status information to the workspace applications.

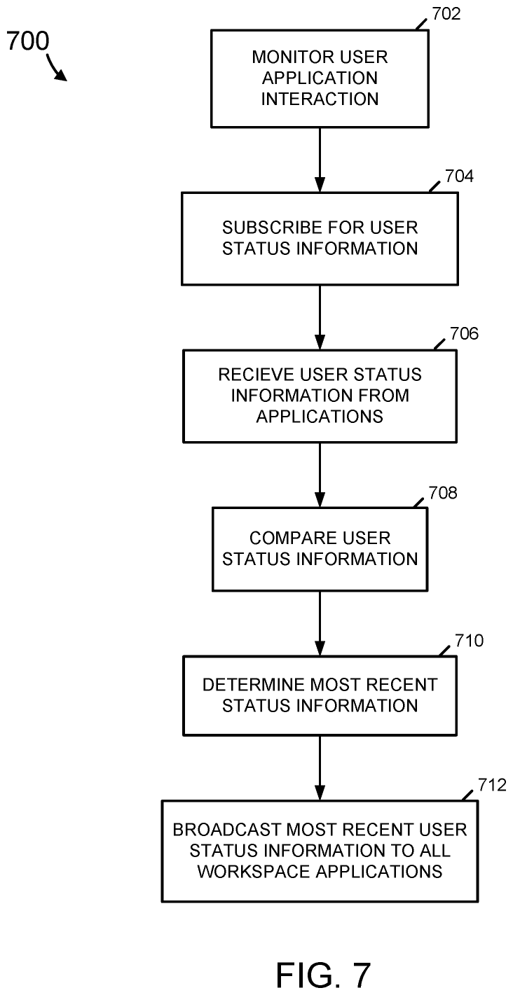

In certain implementations, rather than regularly polling or otherwise monitoring user application interactions to determine current user status information, a subscription model can be used. For example, FIG. 7 illustrates process 700 that includes such a subscription model. As shown in FIG. 7, the processor can execute a software process including one or more instructions, the process configured to monitor 702 user application interaction within a distributed workspace to determine which applications the user has access to and/or interacts with on a regular basis. in such an example, the processor can execute one or more additional instructions to cause the process to subscribe 704 to one or more applications to receive user status information at one or more regular intervals. For example, the subscription information as transmitted by the processor can include instructions to the one or more applications to regularly provide user status updates every minute, every two minutes, every five minutes, every 10 minutes, every 15 minutes, every 30 minutes, every hour, and/or whenever the application determines a change in the current user status information. In some examples, the subscription model can include the processor being further configured to execute an API call at a particular interval to obtain status information from an application API. For example, the processor can be configured to request status information for a particular user at a set time interval and automatically execute the API call at those time intervals to receive or otherwise determine the user status information from the results of the API call.

As further shown in FIG. 7, the processor can execute one or more additional instructions to cause the process to receive 706 the user status information from the one or more applications as defined by the subscription information as described herein. The processor can execute one or more additional instructions to cause the process to compare 708 the user status information as described above with regard to, for example, FIG. 6, and determine 710 the most recent status information for the user. Once determined, the processes can execute one or more additional instructions to cause the process to broadcast 712 the most recent user status information to some or all of the applications within the distributed workspace as described herein.

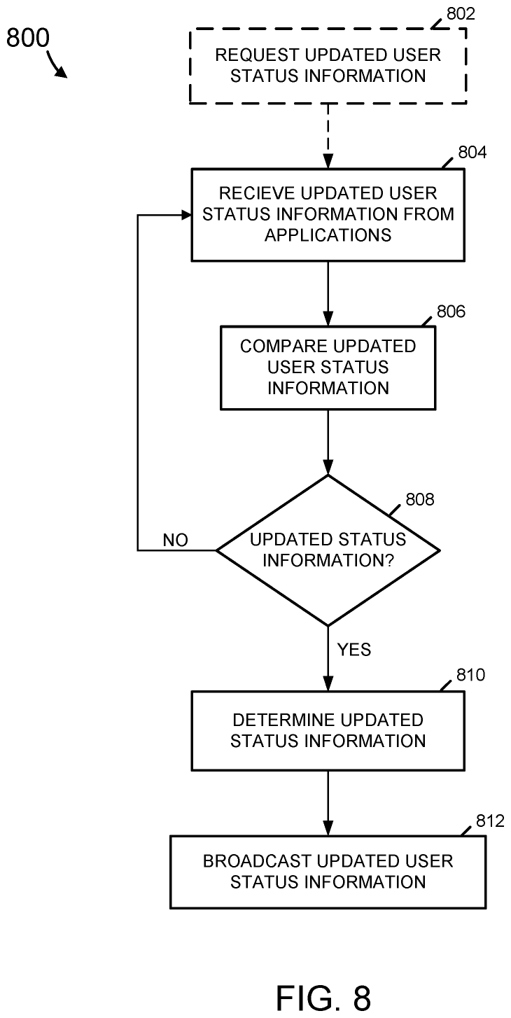

In some examples, in addition to determining the current user status for a user of a workspace application, the systems and methods as described herein can also be used to provide updated user status information over time, FIG. 8 illustrates a sample process 800 that includes providing updated user status information over time as the user status information may change. Depending upon whether the processor has subscribed for user status information, the processor execute a software process including one or more instructions, the process configured to request 802 updated user status information from the one or more distributed workspace applications as described herein. In response, or as defined by the subscription information, the processor can execute one or more additional instructions to cause the process to receive 804 updated user status information from the one or more distributed workspace applications.

As further shown in FIG. 8, the processor can execute one or more additional instructions to cause the process to compare 806 the updated user status information. For example the processor can execute one or more additional instructions to cause the process to compare 806 the updated user status information against the previously broadcast user status information to determine 808 if there are any changes to the user status information. In certain implementations, if the process determines 808 that there is no change in the user status information, the processor can execute one or more additional instructions to cause the process to continue to receive and monitor the user status information for any changes. If the process does determine 808 a change in the user status information, the processor can execute one or more additional instructions to cause the process to determine 810 the most recent updated status information for the user based upon, for example, the timestamp information within the updated status information. The processor can further execute one or more additional instructions to cause the process to broadcast 812 the updated user status information to some or all of the applications within the distributed workspace as described herein.

FIGS. 9 and 10 illustrates sample sequence diagrams 900 and 1000 for requesting and broadcasting current user status information to one or more workspace applications as described herein. More specifically, the sequence diagrams 900 and 1000 show the interactions between various components as described herein including, but not limited to, a syncing agent (e.g., syncing agent 302 as shown in FIG. 3), a syncing service (e.g., the syncing service 304 as shown in FIG. 3), a first distributed workspace application (e.g., messaging application 200 as shown in FIG. 2A), and a second distributed workspace application (e.g., chat application 250 as shown in FIG. 2B).

As shown in sequence diagram 900 of FIG. 9, the syncing agent can request 902 user status information from the first application within a distributed workspace. In response to the request, the syncing agent can receive 904 the user status information. Additionally, the syncing agent can request 906 user status information from the second application within the distributed workspace. In response to the request, the syncing agent can receive 908 the user status information from the second application.

As further shown in FIG. 9, the syncing agent can process 910 the user status information as described herein. For example, the syncing agent can process the user status information from each application to determine a status identifier and time stamp information associated with the user status information. Based upon the time stamp information, the syncing agent can organize a chronological list of user status information and determine the most recent user status information. The syncing agent can further transmit 912 the most recent user status information to the syncing service. The syncing service can then broadcast 914 the user status information to some or all of the applications within the distributed workspace as described herein.

As shown in sequence diagram 1000 of FIG. 10, the syncing agent as described here and can also request and/or receive updated user status information overtime. For example, as shown in sequence diagram 1000, the syncing agent can request 1002 updated user status information from the first application within the distributed workspace. In response to the request, the syncing agent can receive 1004 the updated user status information from the first application. Similarly, the syncing agent can request 1006 updated user status information from the second application within the distributed workspace. In response to this request, the syncing agent can receive 1008 updated user status information from the second application.

As further shown in FIG. 10, the syncing agent can process 1010 the updated user status information to determine if the user status information has changed over a time period. For example, as described herein, the syncing agent can compare 1010 the most recently updated user status information to the previously broadcast user status information. if the updated user status information is the same as the previously broadcast user status information, the syncing agent can continue to monitor the user status information. If, however, the Updated user status information is different than the previously broadcast user status information, the syncing agent can transmit 1012 the most recent user status information to the syncing service. The syncing service can then broadcast 1014 the updated user status information to some or all of the applications within the distributed workspace as described herein.

It should be noted that the processes 600, 700, and 800 as shown in FIGS. 6-8, as well as sequences 900 and 1000 as shown in FIGS. 9 and 10, are provided by way of example only. It should also be noted that the specific process flow, and the order of sequence steps associated with the process and sequence flows as described herein, are provided by way of example only. Various steps contained within the process and sequence flows as described herein can be altered, reordered, or otherwise omitted depending upon the implementation of the techniques as described herein.

### Hardware Implementation Examples

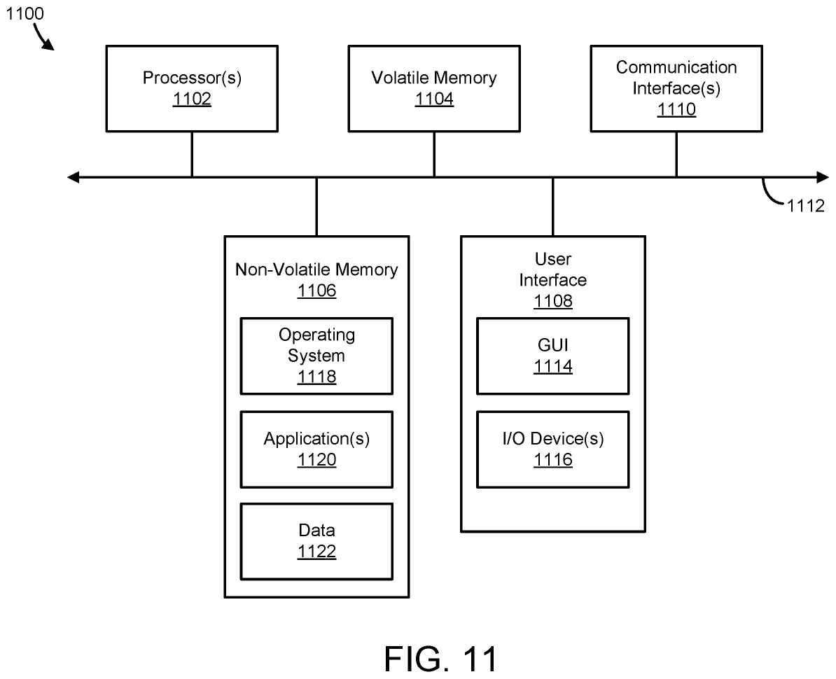

FIG. 11 depicts a block diagram of a computing device 1100 useful for practicing an example of client device 102 and/or workspace host device 110 as shown in FIG. 1 and described above. The computing device 1100 includes one or more processors 1102, volatile memory 1104 (e.g., random access memory (RAM)), non-volatile (non-transitory) memory 1106, UI 1108, one or more communications interfaces 1110, and a communications bus 1112. One or more of the computing devices 1100 can also be referred to as a computer system.

The non-volatile memory 1106 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 1108 can include a graphical user interface (GUI) 1114 (e.g., a touchscreen, a display, etc.) and one or more input/output (I/O) devices 1116 (e.g., a mouse, a keyboard, a microphone, one or more speakers, one or more cameras, one or more biometric scanners, one or more environmental sensors, and one or more accelerometers, etc.).

The non-volatile memory 1106 can store an operating system 1118, one or more applications 1120, and data 1122 such that, for example, computer instructions of the operating system 1118 and/or the applications 1120 are executed by processor(s) 1102 out of the volatile memory 1104. In some examples, the volatile memory 1104 can include one or more types of RAM and/or a cache memory that can offer a faster response time than a main memory. Data can be entered using an input device of the GUI 1114 or received from the I/O device(s) 1116. Various elements of the computing device 1100 can communicate via the communications bus 1112.

The illustrated computing device 1100 is shown merely as an example client device or server and can be implemented by any computing or processing environment with any type of machine or set of machines that can have suitable hardware and/or software capable of operating as described herein.

The processor(s) 1102 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 1102 can be analog, digital or mixed. In some examples, the processor 1102 can include multiple processor cores and/or multiple processors configured to provide functionality for parallel, simultaneous execution of instructions or for parallel, simultaneous execution of one instruction on more than one piece of data.

The communications interfaces 1110 can include one or more interfaces to enable the computing device 1100 to access a computer network such as a Local Area Network (LAN), a Wide Area Network (WAN), a Personal Area Network (PAN), or the Internet through a variety of wired and/or wireless connections, including cellular connections.

In described examples, the computing device 1100 can execute an application on behalf of a user of a client device (e.g., client device 102 as shown in FIG. 1 and described above). For example, the computing device 1100 can execute one or more virtual machines managed by a hypervisor and accessed via, for example, a client agent. Each virtual machine can provide an execution session within which applications execute on behalf of a user or a client device, such as a hosted desktop session. The computing device 1100 can also execute a terminal services session to provide a distributed workspace environment. The computing device 1100 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A computing device configured to determine current user status information, the computing device comprising:
a computer readable memory;
a network interface; and
at least one processor operably coupled to the memory and the network interface and configured to:
receive, via the network interface from a first end-user application being of a first type, a first message specifying status information of a first user,
process the status information of a first user to determine current user status information for the first user,
generate a second message specifying the current user status information for the first user, and
transmit the second message to a second end-user application being of a second type distinct from the type of the first end-user application such that at least one second user can review the current user status information for the first user.

2. The computing device of claim 1, wherein the at least one processor is further configured to:
receive a plurality of first messages specifying status information of the first user;
process the plurality of first messages to generate a chronological list of user status updates; and
determine the current user status information based upon the chronological list of user status updates.

3. The computing device of claim 1, wherein the at least one processor is further configured to poll the first end-user application for the status information of the first user.

4. The computing device of claim 1, wherein the at least one processor is further configured to transmit a subscription request to the first end-user application, the subscription request including one or more instructions to the first end-user application to automatically send the status information of the first user to the at least one processor.

5. The computing device of claim 1, where the at least one processor is further configured to:
receive updated user status information from the first end-user application;
process the updated user status information to generate an updated user status; and
cause the updated user status to be broadcast to a plurality of second end-user applications such that each of the plurality of second end-user applications displays the updated user status to additional users of the plurality of second end-user applications.

6. The computing device of claim 1, wherein the at least one processor is configured to receive the first message specifying status information of a first user from the first end-user application by being configured to:
monitor interaction between the first user and the first end-user application to produce monitored interaction information;
determine real-time activity information for the first user based upon the monitored interaction information; and
generate the second message specifying the current user status information for the first user based upon the real-time activity information.

7. The computing device of claim 1, wherein the user status information comprises an indication that the first user is one or more of on paid time off, away from their computer, currently active in a scheduled activity, available, participating in a chat session, on a call, in a conference meeting, or attending a training session.

8. A method for determining current user status information, the method comprising:
receiving, by at least one processor, a first message specifying status information of a first user from a first end-user application being of a first type;
processing, by the at least one processor, the status information of a first user to determine current user status information for the first user;
generating, by the at least one processor, a second message specifying the current user status information for the first user; and
transmitting, by the at least one processor, the second message to a second end-user application being of a second type distinct from the type of the first end-user application such that at least one second user can review the current user status information for the first user.

9. The method of claim 8, further comprising:
receiving, by the at least one processor, a plurality of first messages specifying status information of the first user;
processing, by the at least one processor, the plurality of first messages to generate a chronological list of user status updates; and
determining, by the at least one processor, the current user status information based upon the chronological list of user status updates.

10. The method of claim 8, further comprising polling, by the at least one processor, the first end-user application for the status information of the first user.

11. The method of claim 8, further comprising transmitting, by the at least one processor, a subscription request to the first end-user application, the subscription request including one or more instructions to the first end-user application to automatically send the status information of the first user to the at least one processor.

12. The method of claim 8, further comprising:
receiving, by the at least one processor, updated user status information from the first end-user application;
processing, by the at least one processor, the updated user status information to generate an updated user status; and
causing, by the at least one processor, the updated user status to be broadcast to a plurality of second end-user applications such that each of the plurality of second end-user applications displays the updated user status to additional users of the plurality of second end-user applications.

13. The method of claim 8, wherein receiving the first message specifying status information of a first user from the first end-user application comprises:
monitoring, by the at least one processor, interaction between the first user and the first end-user application to produce monitored interaction information;
determining, by the at least one processor, real-time activity information for the first user based upon the monitored interaction information; and
generating, by the at least one processor, the second message specifying the current user status information for the first user based upon the real-time activity information.

14. A non-transitory computer-readable medium storing computer-executable instructions to determine current user status information, the instructions comprising instructions to:
receive a first message specifying status information of a first user from a first end-user application being of a first type;
process the status information of a first user to determine current user status information for the first user;
generate a second message specifying the current user status information for the first user; and
transmit the second message to a second end-user application being of a second type distinct from the type of the first end-user application such that at least one second user can review the current use status information for the first user.

15. The non-transitory computer-readable medium of claim 14, further comprising instructions to:
receive a plurality of first messages specifying status information of the first user;
process the plurality of first messages to generate a chronological list of user status updates; and
determine the current user status information based upon the chronological list of user status updates.

16. The non-transitory computer-readable medium of claim 14, further comprising instructions to poll the first end-user application for the status information of the first user.

17. The non-transitory computer-readable medium of claim 14, further comprising instructions to transmit a subscription request to the first end-user application, the subscription request including one or more instructions to the first end-user application to automatically send the status information of the first user to at least one processor.

18. The non-transitory computer-readable medium of claim 14, further comprising instructions to:
receive updated user status information from the first end-user application;
process the updated user status information to generate an updated user status; and
cause the updated user status to be broadcast to a plurality of second end-user applications such that each of the plurality of second end-user applications displays the updated user status to additional users of the plurality of second end-user applications.

19. The non-transitory computer-readable medium of claim 14, wherein the instructions to receive the first message specifying status information of a first user from the first end-user application comprise instructions to:
monitor interaction between the first user and the first end-user application to produce monitored interaction information;
determine real-time activity information for the first user based upon the monitored interaction information; and
generate the second message specifying the current user status information for the first user based upon the real-time activity information.

20. The non-transitory computer-readable medium of claim 14, wherein the user status information comprises an indication that the first user is one or more of on paid time off, away from their computer, currently active in a scheduled activity, available, participating in a chat session, on a call, in a conference meeting, or attending a training session.
